(19) United States
(12) Patent Application Publication
(10) Pub. No.: US 2025/0153439 A1
(43) Pub. Date: May 15, 2025

(54) THREE DIMENSIONAL SHAPING APPARATUS AND CASTING MOLD SHAPING METHOD

(71) Applicant: HONDA MOTOR CO., LTD., TOKYO (JP)

(72) Inventors: Masahito KIMORI, WAKO-SHI (JP); Keisuke YOSHIDA, WAKO-SHI (JP); Kenta KASANO, WAKO-SHI (JP)

(21) Appl. No.: 18/934,794

(22) Filed: Nov. 1, 2024

(30) Foreign Application Priority Data
Nov. 10, 2023 (CN) 202311495882.9

(51) Int. Cl. B29C 64/307; B29C 64/295; B29K 67/00; B29L 31/00; B33Y 10/00; B33Y 30/00; B33Y 40/20; B33Y 80/00

(52) U.S. Cl. CPC B29C 64/307; B29C 64/295; B29K 2067/046; B29L 2031/757; B33Y 10/00; B33Y 30/00; B33Y 40/20; B33Y 80/00

(57) ABSTRACT

A three dimensional shaping apparatus for performing additive manufacturing includes: a table; a head that heats and ejects a thermoplastic shaping material to laminate the thermoplastic shaping material on the table; a squeegee that applies a mold material in a slurry form to laminate the mold material on the table; and a hardening acceleration unit that accelerates hardening of the mold material laminated on the table.

### CROSS-REFERENCE TO RELATED APPLICATIONS

This application is based upon and claims the benefit of priority from Chinese Patent Application No. 202311495882.9 filed on Nov. 10, 2023, the contents of which are incorporated herein by reference.

### BACKGROUND OF THE INVENTION

### Field of the Invention

The present invention relates to a three dimensional shaping apparatus and a casting mold shaping method.

### Description of the Related Art

JP 4374575 B2 discloses a shaping method for producing a gypsum mold by placing a resin model in a mold frame and pouring gypsum into the mold frame.

### SUMMARY OF THE INVENTION

In recent years, there has been a demand for a more satisfactory shaping technique.

The present invention has the object of solving the aforementioned problem.

According to a first aspect of the present invention, provided is a three dimensional shaping apparatus that performs additive manufacturing, the three dimensional shaping apparatus comprising: a table; a head configured to heat and eject a thermoplastic shaping material to laminate the thermoplastic shaping material on the table; a squeegee configured to apply a mold material in a slurry form to laminate the mold material on the table; and a hardening acceleration unit configured to accelerate hardening of the mold material laminated on the table.

According to a second aspect of the present invention, provided is a casting mold shaping method for shaping a casting mold, the casting mold shaping method comprising: a step of shaping a shaped object on a table by additive manufacturing by repeating a lamination process, wherein the lamination process includes a first lamination step of heating and ejecting a thermoplastic shaping material from a head of a three dimensional shaping apparatus to laminate the thermoplastic shaping material on the table, a second lamination step of applying a mold material in a slurry form using a squeegee of the three dimensional shaping apparatus to laminate the mold material on the table, and a hardening acceleration step of accelerating hardening of the mold material laminated on the table by using a hardening acceleration unit of the three dimensional shaping apparatus; and a step of melting the thermoplastic shaping material inside the shaped object and discharging the thermoplastic shaping material that has been melted, thereby obtaining a casting mold formed of the mold material that has been hardened.

According to the present invention, a satisfactory three dimensional shaping apparatus and a satisfactory casting mold shaping method can be provided.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic diagram of a three dimensional shaping apparatus;

FIG. 2A, FIG. 2B, FIG. 2C, FIG. 2D, and FIG. 2E are schematic diagrams illustrating a method for laminating a thermoplastic shaping material and a mold material; and

FIG. 3 is a flowchart of a casting mold shaping process.

### DETAILED DESCRIPTION OF THE INVENTION

In recent years, there has been an increasing need for a three dimensional shaping apparatus capable of shaping a complicated shape that is difficult to form by conventional casting or forging, and there has been a demand for a wide range of its application to mass-produced metal parts manufacturing. However, the cost of metal materials used in three dimensional shaping apparatuses is generally higher than the cost of materials for mass production. In addition, there is a case where the mechanical strength of a shaped object is reduced as compared with a case of a mass production manufacturing method, and therefore, the quality is managed during shaping using an auxiliary device or the shaping speed is reduced to improve the quality. Alternatively, a material having a chemical composition different from that of a conventional metal material may be used. Further, after the completion of the shaping, post-processing such as removal of the shaping support and heat treatment is also required. Therefore, the total shaping time until a shaped object having sufficient quality and mechanical strength is completed increases. As described above, since the material cost is high and the shaping time is long, there is a problem in that the cost of the shaped object increases. In addition, from the viewpoint of realizing a sustainable society, development of a more advanced technology such as shaping of a shaped object using a reusable material has been demanded.

Conventionally, a method is known in which a shaped object obtained using a resin shaping material that is less expensive than metal powder or the like is embedded in a mold material such as gypsum used in casting and is burned out, and then the shaped object is cast. In this method, a process of shaping a model and a process of embedding a shaped object in a mold material are performed as separate processes. According to the present disclosure, a state in which a model is embedded in a mold material can be formed in one process. In addition, the model and the mold portion can be shaped using a material that is relatively easily available and inexpensive. Accordingly, the present disclosure provides a three dimensional shaping apparatus capable of casting a complicated shape that cannot be obtained by a conventional shaping method, and also capable of obtaining a three dimensional shaped object at a lower cost than before.

### Embodiment

### Configuration of Three Dimensional Shaping Apparatus

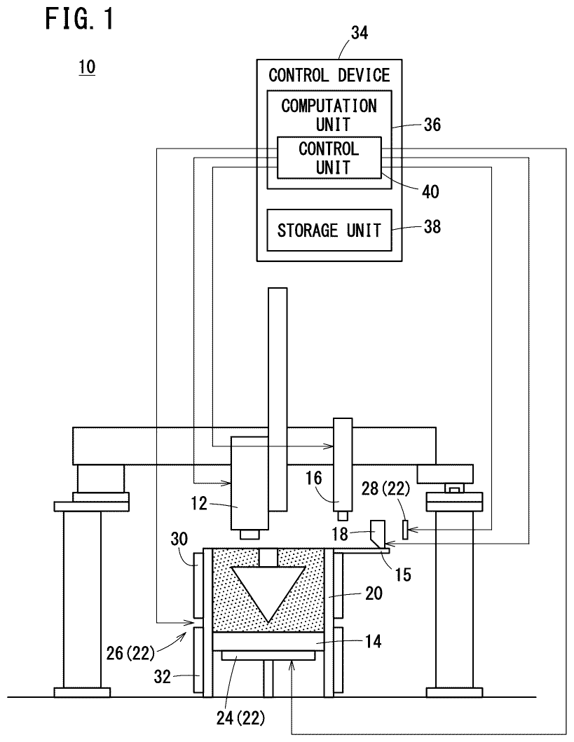

FIG. 1 is a schematic diagram of a three dimensional shaping apparatus 10. The three dimensional shaping apparatus 10 of the present embodiment shapes a model of a casting by laminating a thermoplastic shaping material. Further, the three dimensional shaping apparatus 10 of the present embodiment shapes a casting mold by laminating gypsum, which is a mold material, around the model of the casting. Hereinafter, an object shaped by the laminated thermoplastic shaping material and the laminated mold material may be referred to as a shaped object. When the shaped object is heated, the thermoplastic shaping material in the shaped object is melted. The melted thermoplastic shaping material is discharged from the shaped object and the casting mold formed of the mold material is completed. Molten metal or the like is poured into the casting mold and cooled, and thereafter the casting mold is broken to take out the casting inside the casting mold. The discharged thermoplastic shaping material is preferably used again for forming the model of the casting.

The thermoplastic shaping material may be an oil-and-fat material such as a wax material. The thermoplastic shaping material may be a thermoplastic resin including a vegetable resin such as polylactic acid. The mold material is preferably gypsum in a slurry form, but is not particularly limited thereto and can be selected as appropriate.

The three dimensional shaping apparatus 10 includes a head 12, a table 14, a mold material supply unit 16, a squeegee 18, a storage tank 20, a hardening acceleration unit 22, and a control device 34.

The head 12 ejects the melted thermoplastic shaping material to laminate the thermoplastic shaping material on the table 14. The mold material supply unit 16 supplies a mold material in a slurry form onto a sub-table 15. The squeegee 18 spreads the mold material on the sub-table 15 and applies the mold material onto the thermoplastic shaping material, thereby laminating the mold material on the table 14.

The storage tank 20 stores the thermoplastic shaping material laminated on the table 14 and the mold material laminated on the table 14. The table 14 is movable in the up-down direction in the storage tank 20. The table 14 moves downward each time one layer of the thermoplastic shaping material and the mold material is laminated.

The hardening acceleration unit 22 includes a first temperature adjuster 24, a second temperature adjuster 26, and a blower 28. The first temperature adjuster 24 is provided on the table 14. The first temperature adjuster 24 may be a heater. The first temperature adjuster 24 heats the thermoplastic shaping material laminated on the table 14 and the mold material laminated on the table 14, whereby hardening of the mold material is accelerated.

The first temperature adjuster 24 is controlled so that the temperatures of the heated thermoplastic shaping material and the heated mold material become a predetermined temperature. For example, in a case where the thermoplastic shaping material is an oil-and-fat material such as a wax material, the predetermined temperature is a temperature in a range of 30° C. to 60° C., but is not limited thereto as long as the temperature is equal to or lower than the melting temperature of the oil-and-fat material.

In addition, in a case where the thermoplastic shaping material is a thermoplastic resin including a vegetable resin such as polylactic acid, it is desirable to control the predetermined temperature to about 50° C. to 70° C. so that the resin melted and softened by the head 12 is brought into close contact with the upper surface of the table 14. The predetermined temperature can be appropriately controlled in accordance with the properties of the selected thermoplastic resin.

In a case where the temperature of the thermoplastic shaping material is too low, the contact angle of the thermoplastic shaping material with respect to the mold material increases, and the wettability decreases. Therefore, the thermoplastic shaping material does not adhere to the mold material. On the other hand, in a case where the temperature of the thermoplastic shaping material is too high, the contact angle of the thermoplastic shaping material with respect to the mold material decreases, and the wettability increases. This may cause the thermoplastic shaping material to penetrate into the mold material. By controlling the temperatures of the thermoplastic shaping material and the mold material to be the predetermined temperature, it is possible to maintain a state where the thermoplastic shaping material appropriately adheres to the mold material while hardening of the mold material is accelerated. This can improve the accuracy of the shaped object.

The second temperature adjuster 26 is provided on a side surface of the storage tank 20. The second temperature adjuster 26 includes an upper temperature adjuster 30 and a lower temperature adjuster 32. The upper temperature adjuster 30 may be a heater. The lower temperature adjuster 32 may be a heater. The upper temperature adjuster 30 and the lower temperature adjuster 32 heat the thermoplastic shaping material laminated on the table 14 and the mold material laminated on the table 14, whereby hardening of the mold material is accelerated. The upper temperature adjuster 30 and the lower temperature adjuster 32 are controlled so that the temperatures of the heated thermoplastic shaping material and the heated mold material become the predetermined temperature.

The amount of heat output from the lower temperature adjuster 32 may be smaller than the amount of heat output from the upper temperature adjuster 30. The thermoplastic shaping material and the mold material located on the lower side are more likely to retain heat than the thermoplastic shaping material and the mold material located on the upper side. Therefore, in a case where the thermoplastic shaping material located on the lower side is heated in the same manner as the thermoplastic shaping material located on the upper side, the thermoplastic shaping material may melt and penetrate into the mold material. By making the amount of heat output by the lower temperature adjuster 32 smaller than the amount of heat output by the upper temperature adjuster 30, it is possible to suppress the penetration of the thermoplastic shaping material into the mold material.

The lower temperature adjuster 32 may be a cooler. The thermoplastic shaping material and the mold material may be cooled instead of being heated by the lower temperature adjuster 32 serving as a cooler. Alternatively, a lower temperature adjuster 32 capable of appropriately performing heating and cooling may be provided.

The blower 28 blows air to the thermoplastic shaping material laminated on the table 14 and the mold material laminated on the table 14, thereby drying the thermoplastic shaping material and the mold material. This accelerates the hardening of the thermoplastic shaping material and the mold material. The temperature of the air sent out from the blower 28 may be higher than the temperature of the air around the blower 28. The temperature of the air sent out from the blower 28 may be lower than the temperature of the air around the blower 28. The temperature of the air sent out from the blower 28 may be the same as the temperature of the air around the blower 28.

The control device 34 controls the head 12, the mold material supply unit 16, the squeegee 18, the first temperature adjuster 24, the second temperature adjuster 26, and the blower 28.

The control device 34 includes a computation unit 36 and a storage unit 38. The computation unit 36 is, for example, a processor such as a central processing unit (CPU) or a graphics processing unit (GPU). The computation unit 36 includes a control unit 40. The control unit 40 is realized by the computation unit 36 executing a program stored in the storage unit 38. At least part of the control unit 40 may be realized by an integrated circuit such as an application specific integrated circuit (ASIC) or a field-programmable gate array (FPGA). At least part of the control unit 40 may be realized by an electronic circuit including a discrete device. The head 12, the mold material supply unit 16, the squeegee 18, the first temperature adjuster 24, the second temperature adjuster 26, and the blower 28 are controlled by the control unit 40.

Further, when the thermoplastic shaping material and the mold material are changed, the control device 34 performs optimum temperature control as appropriate. As a result, even in a case where the thermoplastic shaping material and the mold material are changed, the thermoplastic shaping material and the mold material are laminated in a state where the temperatures thereof are controlled to be appropriate according to the properties of the thermoplastic shaping material and the mold material. Therefore, the accuracy of the shaped object can be maintained.

The storage unit 38 is a computer-readable storage medium. The storage medium is constituted by a volatile memory (not shown) and a non-volatile memory (not shown). The volatile memory is, for example, a random access memory (RAM) or the like. The non-volatile memory is, for example, a read only memory (ROM), a flash memory, or the like. Data and the like are stored in, for example, the volatile memory. Programs, tables, maps, and the like are stored in, for example, the non-volatile memory. At least part of the storage unit 38 may be included in the processor, the integrated circuit, or the like described above. At least part of the storage unit 38 may be mounted on a device connected to the three dimensional shaping apparatus 10 via a network.

### Lamination Method

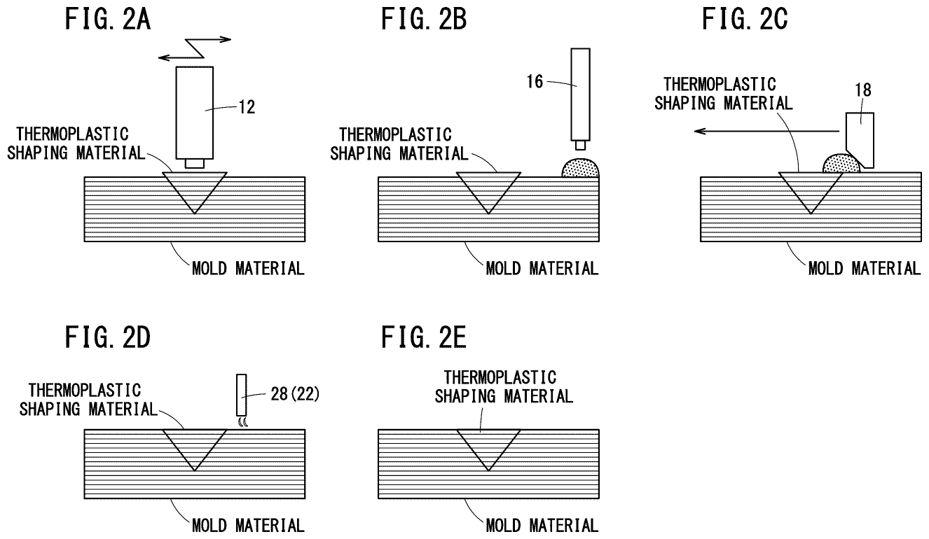

FIGS. 2A to 2E are schematic diagrams illustrating a method for laminating the thermoplastic shaping material and the mold material. As shown in FIG. 2A, the head 12 ejects the thermoplastic shaping material to laminate one layer of the thermoplastic shaping material. Next, as shown in FIG. 2B, the mold material supply unit 16 supplies the mold material. In FIG. 2B, the mold material is supplied onto the laminated mold material, but the mold material may be supplied onto the sub-table 15 shown in FIG. 1. Next, as shown in FIG. 2C, the squeegee 18 spreads the mold material, and additionally applies the mold material onto the mold material which has been already applied. As shown in FIG. 2D, the blower 28 blows air to the thermoplastic shaping material and the mold material after the squeegee 18 has passed therethrough, to dehumidify the thermoplastic shaping material and the mold material. When the squeegee 18 finishes spreading the mold material, one layer of the mold material is laminated as shown in FIG. 2E.

### Casting Mold Shaping Process

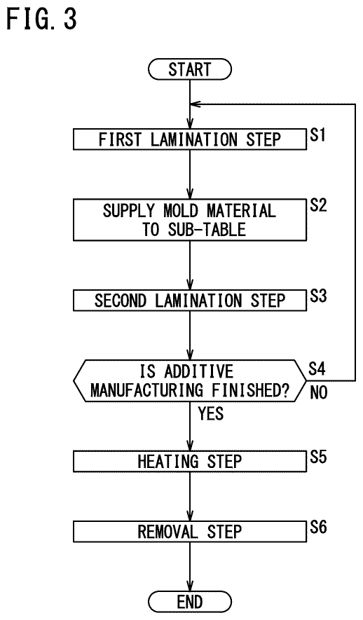

FIG. 3 is a flowchart of a casting mold shaping process.

In step S1, the control unit 40 of the control device 34 executes a first lamination step. Thereafter, the process proceeds to step S2. In the first lamination step, the control unit 40 controls the head 12 to eject the melted thermoplastic shaping material from the head 12. Consequently, the thermoplastic shaping material is laminated on the table 14.

In step S2, the control unit 40 controls the mold material supply unit 16 to supply the mold material to the sub-table 15. Thereafter, the process proceeds to step S3.

In step S3, the control unit 40 executes a second lamination step. In the second lamination step, the control unit 40 controls the squeegee 18 so that the mold material is applied by the squeegee 18. Consequently, the mold material is laminated on the table 14. Thereafter, the process proceeds to step S4. One layer of the thermoplastic shaping material and the mold material is laminated by performing a lamination process in step S1 to step S3. While the lamination process is performed, a hardening acceleration step of accelerating hardening of the mold material is consecutively performed by the first temperature adjuster 24, the second temperature adjuster 26, and the blower 28.

In step S4, the control unit 40 determines whether or not additive manufacturing (lamination shaping) of the shaped object is finished. In a case where the control unit 40 determines that the additive manufacturing is finished, the process proceeds to step S5. In a case where the control unit 40 determines that the additive manufacturing is not finished, the process returns to step S1.

In step S5, a heating step is performed. In the heating step, the shaped object obtained by the additive manufacturing is heated to melt the thermoplastic shaping material inside the shaped object. The heating of the shaped object may be performed by the first temperature adjuster 24 and the second temperature adjuster 26. The heating of the shaped object may be performed by an apparatus different from the three dimensional shaping apparatus 10. The heating step may be performed by a user.

In step S6, a removal step is performed. Thereafter, the casting mold shaping process is ended. In the removal step, the melted thermoplastic shaping material is discharged from the shaped object. The removal step may be performed by the user. As a result, the casting mold is completed.

The following supplementary notes are further disclosed in relation to the above-described disclosure.

### Supplementary Note 1

Provided is the three dimensional shaping apparatus (10) that performs additive manufacturing, the three dimensional shaping apparatus including: the table (14); the head (12) configured to heat and eject the thermoplastic shaping material to laminate the thermoplastic shaping material on the table; the squeegee (18) configured to apply the mold material in a slurry form to laminate the mold material on the table; and the hardening acceleration unit (22) configured to accelerate hardening of the mold material laminated on the table. According to such a configuration, the mold material laminated on the table can be satisfactorily hardened. Therefore, according to such a configuration, it is possible to provide a satisfactory three dimensional shaping apparatus.

### Supplementary Note 2

In the three dimensional shaping apparatus according to supplementary note 1, the hardening acceleration unit may be the first temperature adjuster (24) provided on the table, and the first temperature adjuster may heat the thermoplastic shaping material laminated on the table and the mold material laminated on the table. According to such a configuration, the mold material laminated on the table can be satisfactorily hardened.

### Supplementary Note 3

In the three dimensional shaping apparatus according to supplementary note 1 or 2, the hardening acceleration unit may be the blower (28) configured to send air, and the blower may blow the air to the thermoplastic shaping material laminated on the table and the mold material laminated on the table. According to such a configuration, the mold material laminated on the table can be satisfactorily hardened.

### Supplementary Note 4

The three dimensional shaping apparatus according to supplementary note 1 or 2 may further include the storage tank (20) configured to store the thermoplastic shaping material laminated on the table and the mold material laminated on the table, wherein the hardening acceleration unit may be the second temperature adjuster (26) provided on the side surface of the storage tank, and the second temperature adjuster may heat the thermoplastic shaping material laminated on the table and the mold material laminated on the table. According to such a configuration, the mold material laminated on the table can be satisfactorily hardened.

### Supplementary Note 5

In the three dimensional shaping apparatus according to supplementary note 1 or 2, the thermoplastic shaping material may be an oil and fat including a wax material, or a thermoplastic resin including polylactic acid. According to such a configuration, the mold material laminated on the table can be satisfactorily hardened.

### Supplementary Note 6

Provided is the casting mold shaping method for shaping the casting mold, the casting mold shaping method including: the step of shaping the shaped object on the table by additive manufacturing by repeating the lamination process, wherein the lamination process includes the first lamination step of heating and ejecting the thermoplastic shaping material from the head of the three dimensional shaping apparatus to laminate the thermoplastic shaping material on the table, the second lamination step of applying the mold material in a slurry form using the squeegee of the three dimensional shaping apparatus to laminate the mold material on the table, and the hardening acceleration step of accelerating hardening of the mold material laminated on the table by using the hardening acceleration unit of the three dimensional shaping apparatus; and the step of melting the thermoplastic shaping material inside the shaped object and discharging the thermoplastic shaping material that has been melted, thereby obtaining the casting mold formed of the mold material that has been hardened. According to such a configuration, the mold material laminated on the table can be satisfactorily hardened.

### Supplementary Note 7

In the casting mold shaping method according to supplementary note 6, the hardening acceleration unit may be the first temperature adjuster provided on the table, and in the hardening acceleration step, the first temperature adjuster may heat the thermoplastic shaping material laminated on the table and the mold material laminated on the table. According to such a configuration, the mold material laminated on the table can be satisfactorily hardened.

### Supplementary Note 8

In the casting mold shaping method according to supplementary note 6 or 7, the hardening acceleration unit may be the blower configured to send air, and in the hardening acceleration step, the blower may blow the air to the thermoplastic shaping material laminated on the table and the mold material laminated on the table. According to such a configuration, the mold material laminated on the table can be satisfactorily hardened.

### Supplementary Note 9

In the casting mold shaping method according to supplementary note 6 or 7, the hardening acceleration unit may be the second temperature adjuster provided on the side surface of the storage tank configured to store the thermoplastic shaping material laminated on the table and the mold material laminated on the table, and in the hardening acceleration step, the second temperature adjuster may heat the thermoplastic shaping material laminated on the table and the mold material laminated on the table. According to such a configuration, the mold material laminated on the table can be satisfactorily hardened.

The present invention is not limited to the above disclosure, and various modifications are possible without departing from the essence and gist of the present invention.

1. A three dimensional shaping apparatus that performs additive manufacturing, the three dimensional shaping apparatus comprising:
a table;
a head configured to heat and eject a thermoplastic shaping material to laminate the thermoplastic shaping material on the table;
a squeegee configured to apply a mold material in a slurry form to laminate the mold material on the table; and
a hardening acceleration unit configured to accelerate hardening of the mold material laminated on the table.

2. The three dimensional shaping apparatus according to claim 1, wherein
the hardening acceleration unit is a first temperature adjuster provided on the table, and
the first temperature adjuster heats the thermoplastic shaping material laminated on the table and the mold material laminated on the table.

3. The three dimensional shaping apparatus according to claim 1, wherein
the hardening acceleration unit is a blower configured to send air, and
the blower blows the air to the thermoplastic shaping material laminated on the table and the mold material laminated on the table.

4. The three dimensional shaping apparatus according to claim 1, further comprising
a storage tank configured to store the thermoplastic shaping material laminated on the table and the mold material laminated on the table, wherein
the hardening acceleration unit is a second temperature adjuster provided on a side surface of the storage tank, and
the second temperature adjuster heats the thermoplastic shaping material laminated on the table and the mold material laminated on the table.

5. The three dimensional shaping apparatus according to claim 1, wherein
the thermoplastic shaping material is an oil and fat including a wax material, or a thermoplastic resin including polylactic acid.

6. A casting mold shaping method for shaping a casting mold, the casting mold shaping method comprising:
shaping a shaped object on a table by additive manufacturing by repeating a lamination process, wherein the lamination process includes heating and ejecting a thermoplastic shaping material from a head of a three dimensional shaping apparatus to laminate the thermoplastic shaping material on the table, applying a mold material in a slurry form using a squeegee of the three dimensional shaping apparatus to laminate the mold material on the table, and accelerating hardening of the mold material laminated on the table by using a hardening acceleration unit of the three dimensional shaping apparatus; and
melting the thermoplastic shaping material inside the shaped object and discharging the thermoplastic shaping material that has been melted, thereby obtaining a casting mold formed of the mold material that has been hardened.

7. The casting mold shaping method according to claim 6, wherein
the hardening acceleration unit is a first temperature adjuster provided on the table, and
in the accelerating of the hardening, the first temperature adjuster heats the thermoplastic shaping material laminated on the table and the mold material laminated on the table.

8. The casting mold shaping method according to claim 6, wherein
the hardening acceleration unit is a blower configured to send air, and
in the accelerating of the hardening, the blower blows the air to the thermoplastic shaping material laminated on the table and the mold material laminated on the table.

9. The casting mold shaping method according to claim 6, wherein
the hardening acceleration unit is a second temperature adjuster provided on a side surface of a storage tank configured to store the thermoplastic shaping material laminated on the table and the mold material laminated on the table, and
in the accelerating of the hardening, the second temperature adjuster heats the thermoplastic shaping material laminated on the table and the mold material laminated on the table.
